(19) United States
(12) Patent Application Publication
(10) Pub. No.: US 2008/0082233 A1
(43) Pub. Date: Apr. 3, 2008

(54) Traveling vehicle

(75) Inventor: Koki Hayashi, Tokyo (JP)

Correspondence Address: BACON & THOMAS, PLLC, 625 SLATERS LANE, FOURTH FLOOR, ALEXANDRIA, VA, 22314, US

(73) Assignee: Kabushikikaisha Equos Research, Tokyo (JP)

(21) Appl. No.: 11/898,686

(22) Filed: Sep. 14, 2007

(30) Foreign Application Priority Data
Sep. 29, 2006 (JP) 2006-266693

(51) Int. Cl. B60Q 11/00; B60Q 1/44

(52) U.S. Cl. 701/36

(57) ABSTRACT

Disclosed is a traveling vehicle provided with an input device of a speed-command type. The traveling vehicle includes a vehicle speed sensor that detects a traveling speed V_{R} of the traveling vehicle, a target speed-setting unit that sets a target speed V_{T} based on the position of the input device, and a brake light controller that calculates the difference ΔV between the traveling speed V_{R} and the target speed V_{T} by subtracting the target speed V_{T} from the traveling speed V_{R} and turns on brake lights if the difference ΔV is not less than a predetermined value.

### INCORPORATION BY REFERENCE

The disclosure of Japanese Patent Application No. 2006-266693 filed on Sep. 29, 2006 including the specification, drawings and abstract is incorporated herein by reference in its entirety.

### BACKGROUND OF THE INVENTION

1. Field of the Invention

The present invention is related to a traveling vehicle that includes an input device of a speed-command type and brake lights.

2. Description of the Related Art

There exist known traveling vehicles in which an attitude detection sensor, such as an acceleration sensor or a gyro sensor, detects the angular change of the vehicle body when the occupant on the vehicle's step base leans the vehicle body and then a control unit, upon receiving a signal from the sensor, sends a drive signal to the wheel drive motor according to the angular change of the vehicle body. For example, Japanese Patent Application Publication No. JP-A-2005-335570 discloses one such traveling vehicle that causes the attitude detection sensor to detect the tilt of the vehicle body and the behavior of the occupant and automatically turn on or blink the brake lights corresponding to the tilt of the vehicle body and the behavior of the occupant without occupant's operation, thereby signaling to the vehicle behind that this traveling vehicle is braking.

While the foregoing vehicle achieves its intended objective, it is not free from certain problems and inconveniences. For example, in a vehicle that employs an input device of a speed-command type, such as a slider knob or a joystick, whose command position corresponds to the target speed, if the tilt of the vehicle body and the behavior of the occupant are detected by an attitude detection sensor so as to control the brake lights as in the invention disclosed in the foregoing Japanese Patent Application Publication No. JP-A-2005-335570, the actual tilt of the vehicle may not necessarily correspond to what is intended by the occupant. Accordingly, accurate control is not possible according to this technology.

### SUMMARY OF THE INVENTION

In order to solve the above-identified problems, the present invention has an objective to provide a traveling vehicle including an input device of a speed-command type that accurately signals the vehicle behind that this traveling vehicle is braking.

In view of the above, the present invention provides a traveling vehicle having an input device of a speed-command type, the traveling vehicle including: a vehicle speed sensor for detecting a traveling speed of the traveling vehicle; a target speed-setting unit for setting a target speed based on a position of the input device; and a brake light controller for calculating the difference between the traveling speed and the target speed by subtracting the target speed from the traveling speed and turning on a brake light if the difference is not less than a predetermined value. This arrangement enables the occupant of the traveling vehicle to accurately signal the vehicle behind that this vehicle is decelerating.

In one aspect, the input device has a neutral position where the target speed is zero. Additionally, the brake light controller calculates a moving speed of the input device and turns on the brake light if the moving speed is greater than a predetermined value with the input device moving toward the neutral position. This arrangement permits the brake light to turn on more promptly, thus enabling the occupant of the traveling vehicle to more quickly and accurately signal the vehicle behind that this vehicle is decelerating.

In another aspect, the brake light controller controls the operating conditions of the brake light according to the size of the difference. This arrangement enables the occupant of the traveling vehicle to signal the vehicle behind more specifically about the deceleration of this vehicle.

In still another aspect, the brake light controller controls the operating conditions of the brake light according to the moving speed of the input device. This enables the occupant of the traveling vehicle to signal the vehicle behind more specifically about the deceleration of this vehicle.

### BRIEF DESCRIPTION OF THE DRAWINGS

FIG. 1 shows a traveling vehicle of an embodiment according to the present invention;

FIG. 2 shows a balancer of the embodiment;

FIG. 3 shows a block diagram of the embodiment;

FIG. 4 shows a slider knob of the embodiment;

FIG. 5 shows a block diagram representing the control of brake lights according to the embodiment;

FIG. 6 is a flowchart describing the control of the brake lights according to the embodiment;

FIG. 7 shows the correlation between the difference ΔV between the traveling speed V_{R} and the target speed V_{T} of the vehicle and the brightness B1 according to the embodiment;

FIG. 8 shows the correlation between the moving speed V_{N} of the slider knob 6 and the brightness B2 according to the embodiment; and

FIG. 9 shows a flowchart describing the manner in which the operating conditions of the brake lights are controlled.

### DETAILED DESCRIPTION OF THE PREFERRED EMBODIMENTS

An embodiment of the present invention will be described hereafter with reference to the attached drawings.

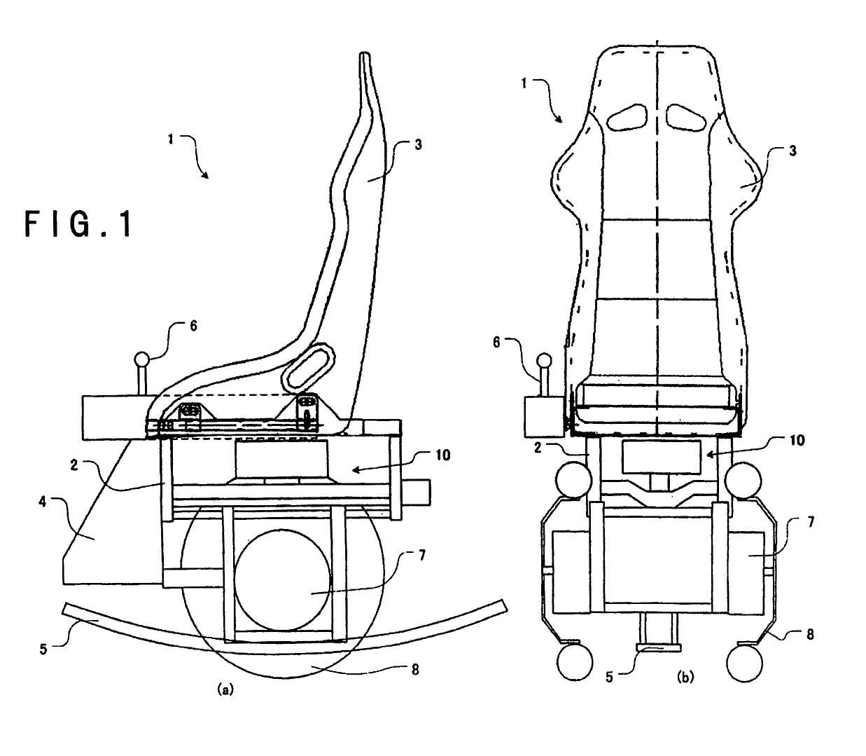

FIG. 1 shows a traveling vehicle 1 of the embodiment. The traveling vehicle 1 includes a vehicle body 2, a occupant mount 3, such as a seat, a footrest 4, a safety bar 5 against overturning, an input device 6, such as a slider knob, a pair of drive mechanisms 7, such as right and left wheel motors, a pair of wheels 8, and a balancer 10. The vehicle body 2 mounts the seat 3 for seating an occupant M in its upper portion, the balancer 10 in its approximately center portion, the footrest 4, on which occupant M's legs are rested, in its front portion, and the safety bar 5, which extends along the vehicle's fore-and-aft direction, in its lower portion. The seat 3 is supported by the vehicle body and provided with a bottom portion 3a on which the occupant M sits and a seatback 3b on which the occupant M leans. The seatback 3b preferably extends higher that the head of the occupant M when the seat 3 is occupied by the occupant M. The slider knob 6 is supported by the vehicle body 2 for its operation by the occupant M in the seat 3. The right and left wheel motors 7 are supported by the vehicle body 2 on a common axis and their forward and rearward driving force may be independently controlled. Moreover, the wheel motors 7 are coupled to the respective wheels 8, which are rotatably supported by the vehicle body 2. The balancer 10, which controls an attitude of the traveling vehicle 1, is mounted on the vehicle body 2.

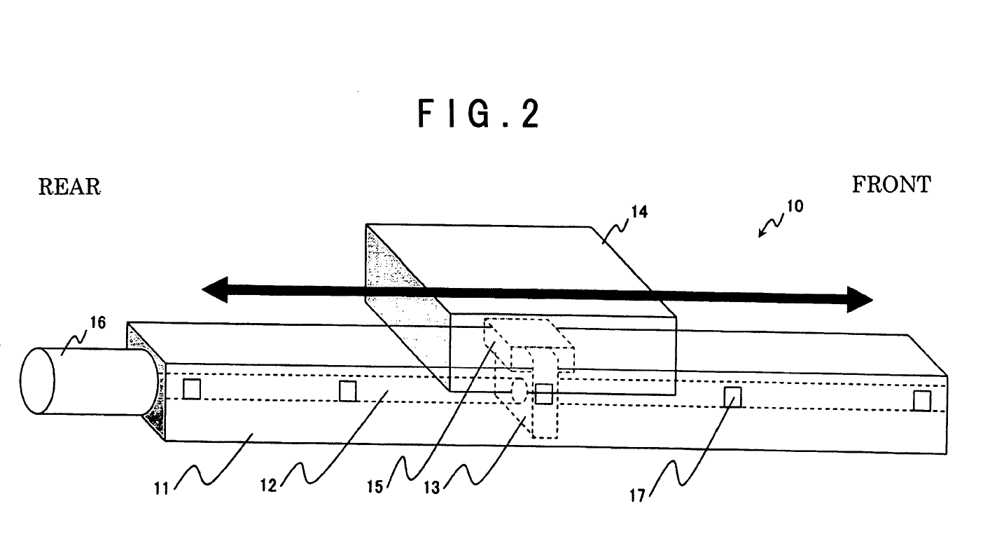

FIG. 2 shows the balancer 10 of the preferred embodiment. The balancer 10 includes a rail 11, a ball screw 12 mounted on the rail 11, a slider 15 supported on the ball screw 12 via a nut block 13, and a deadweight 14 mounted on the slider 15. The balancer 10 additionally includes a balancer actuator 16, such as a servomotor, that causes the slider 15 to travel along the rail 11. The balancer 10 also includes balancer position sensors 17 for detecting the location of the deadweight 14. A battery, an ECU or the like may be used as the deadweight 14.

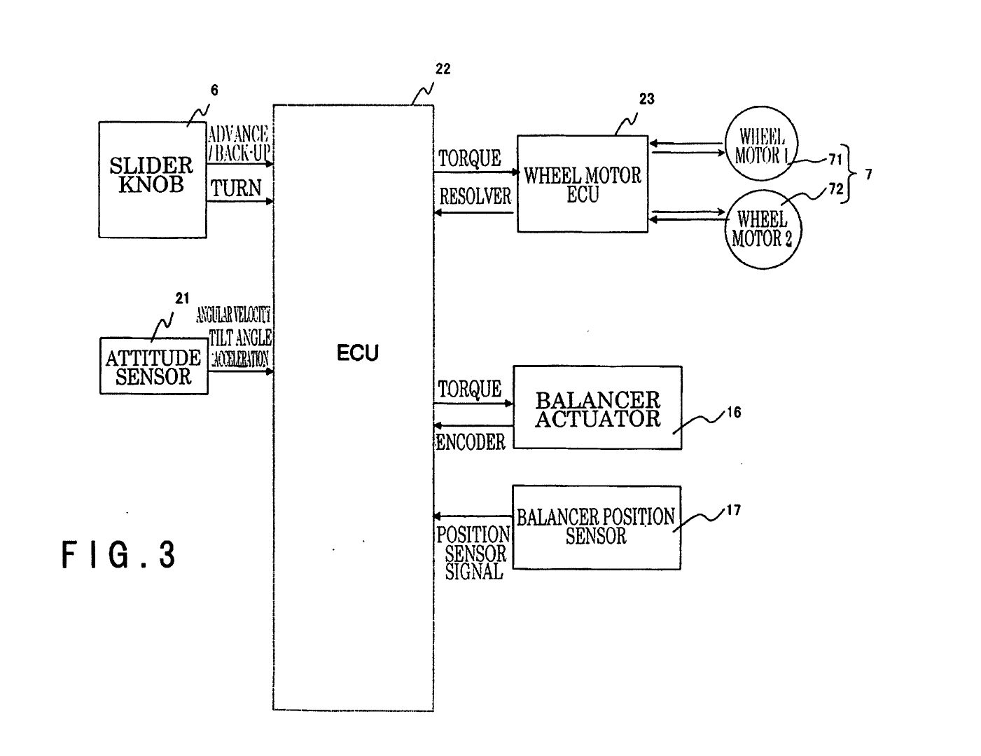

FIG. 3 shows a block diagram of this embodiment that includes the slider knob 6, the drive mechanisms, such as the first and second wheel motors 71 and 72, respectively, a vehicle attitude detection unit, such as a attitude sensor 21, a vehicle attitude control unit, such as ECU 22, another vehicle attitude control unit, such as a wheel motor ECU 23, the balancer actuator 16, and the balancer position sensor 17.

The slider knob 6 is operated by the occupant to advance, back up, and turn the traveling vehicle 1. The information about the amount of slider knob operation by the occupant and other related values are sent to the ECU 22. The attitude sensor 21 detects the attitude of the vehicle body 2, such as the angular velocity, the tilt angle, and the acceleration, and sends signals representing these measured values to the ECU 22. Based on the values detected by the attitude sensor 21, the ECU 22 sends signals for controlling the attitude of the vehicle body to the various actuators.

The traveling vehicle 1 travels while maintaining its attitude by: receiving as inputs the values representing the operation of the slider knob 6 by the occupant M for vehicle advancement, backing up, and turning, the attitude values detected by the attitude sensor 21 indicating the angular velocity, the tilt angle, and the acceleration of the vehicle body 2, the resolver output of the wheel motors 7 and the counter encoder output of the balancer actuator 16; causing the ECU 22 and the wheel motor ECU 23 to control the first and second wheel motors 71 and 72; and causing the ECU 22 to control the balancer actuator 16.

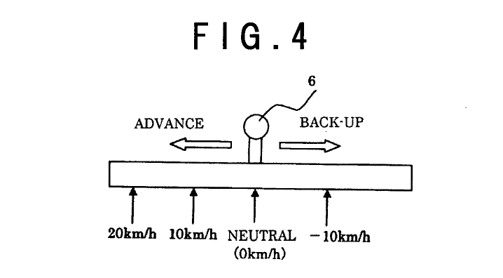

The control of the brake lights according to the embodiment will be described hereafter. First, the operation of the slider knob 6 will be described with reference to FIG. 4. When the traveling vehicle 1 is stationary, the slider knob 6 is maintained in a neutral position in which the target speed of the traveling vehicle 1 is zero. Forward or rearward movement of the slider knob 6 sets a target speed of the traveling vehicle that corresponds to the knob position. The slider knob 6 may be adapted such that the turning angle of the traveling vehicle 1 can be set by tilting the slider knob 6 in a lateral direction (either to the right or left). It should be noted that the relationship between the position of the slider knob 6 and the speed of the traveling vehicle need not be linear. For example, the amount of slider knob movement for commanding a vehicle speed of 20 km/h for advancement need not be the same as that for commanding a vehicle speed of 20 km/h for backing up. Likewise, the amount of slider knob movement for commanding a vehicle speed of 20 km/h in the forward direction need not be twice that for commanding a vehicle speed of 10 km/h in the forward direction.

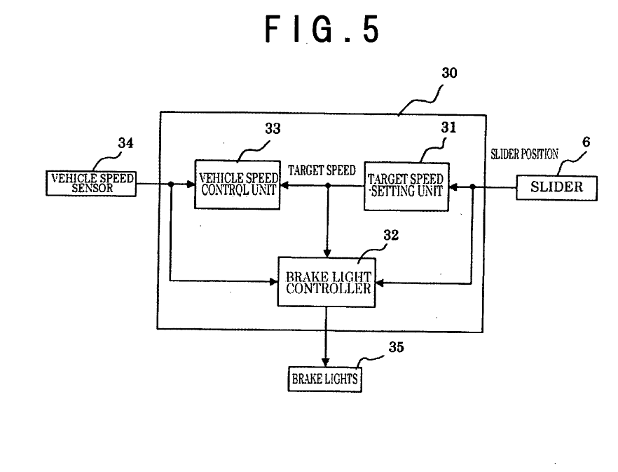

FIG. 5 is a block diagram representing the control of the brake lights according to the embodiment. As shown in the drawing, the control of the brake lights according to the embodiment employs an input device, such as the slider knob 6, a brake light control unit 30, a target speed-setting unit 31, a brake light controller 32, a vehicle speed control unit 33, a vehicle speed sensor 34, and the brake lights 35.

The brake light control unit 30 includes the target speed-setting unit 31, the brake light controller 32, and the vehicle speed control unit 33 and receives information representing the traveling speed V_{R} of the traveling vehicle 1 detected by the vehicle speed sensor 34 and the position p of the slider knob 6 as its inputs to control the operation of the brake lights 35. The brake light control unit 30 may be provided either as part of the ECU 22 or as a separate unit.

Upon receiving the information about the position of the slider knob 6, the target speed-setting unit 31 calculates and sets the target speed V_{T} based on the positional information. For example, this calculation may be performed by inputting the position of the slider knob 6 detected as a voltage value into a function that converts it to the target speed V_{T}. It should be noted that this function is not limited to such a mathematical formula and that a lookup table or the like may be employed that correlates positions of the slider knob 6 with target speeds V_{T}.

The stop light controller 32 receives as its inputs the traveling speed V_{R} of the traveling vehicle 1 detected by the vehicle speed sensor 34, the position p of the slider knob 6, and the target speed V_{T} calculated by the target speed-setting unit 31 so as to control the operation of the brake lights 35.

The vehicle speed control unit 33 receives as its inputs the target speed V_{T} calculated by the target speed-setting unit 31 and the traveling speed V_{R} of the traveling vehicle 1 detected by the vehicle speed sensor 34 so as to control the traveling speed V_{R} of the traveling vehicle 1.

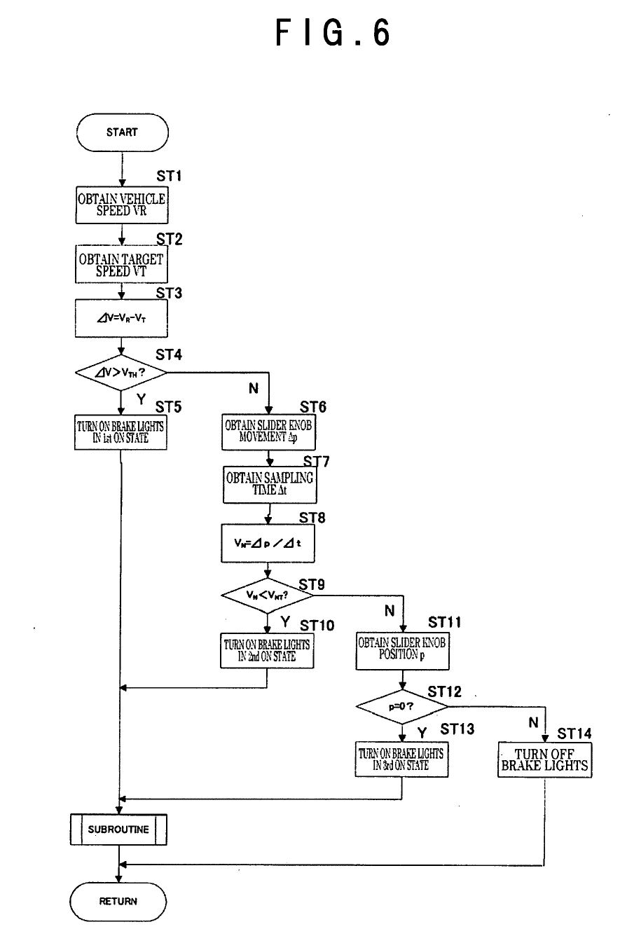

The manner of controlling the operation of the brake lights according to the embodiment will be described hereafter with reference to the flowchart of FIG. 6.

First, in Step 1 (ST1), the traveling speed V_{R} of the vehicle is obtained from the vehicle speed sensor 34 and in the subsequent Step 2 (ST2), the target speed V_{T} is obtained from the target speed-setting unit 31. In Step 3 (ST3), the difference ΔV between the traveling speed V_{R} and the target speed V_{T} is calculated.

Since the brake lights 35 are caused to turn on when the target speed V_{T} is lower than the traveling speed V_{R}, the condition for turning on the brake lights 35 could be as follows:
V_{R}−V_{T}=ΔV>0.

If the condition of ΔV>0 is strictly applied, the brake lights 35 might frequently switch on and off. Accordingly, from a practical standpoint, a suitable predetermined value (such as a threshold V_{TH}) rather than 0 or larger is employed so as to turn on the brake lights 35 when the difference ΔV is not less than the threshold V_{TH}.

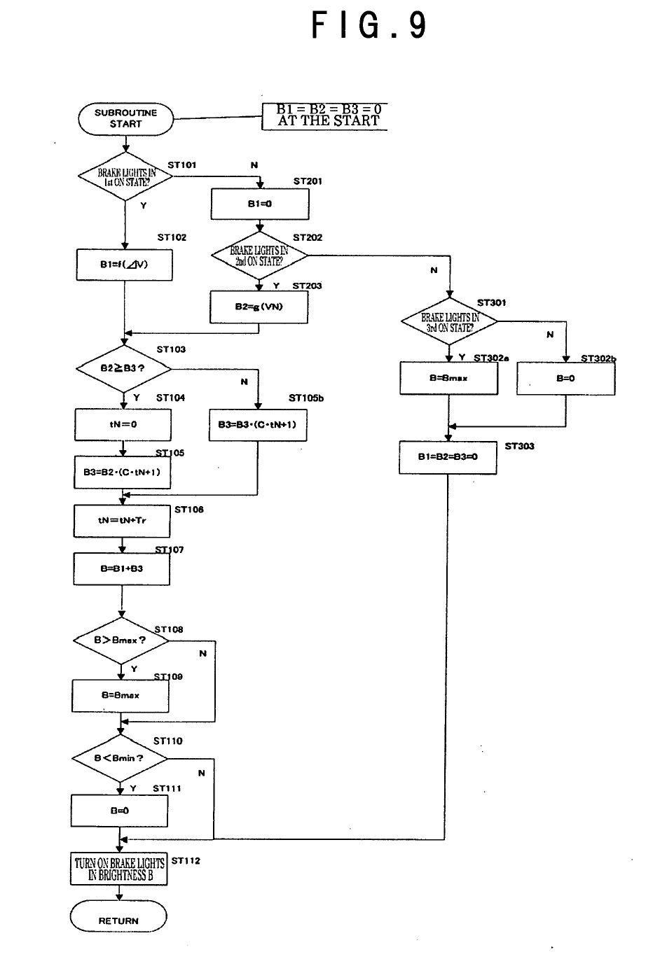

Accordingly, it is determined in Step 4 (ST4) whether ΔV>V_{TH}. If ΔV>V_{TH}, the process goes to Step 5 (ST5), where the brake lights 35 are switched on in a first brake light ON state and the subroutine illustrated in FIG. 9 is executed.

In this way, by determining whether ΔV>V_{TH} and switching on the brake lights 35 in the first brake light ON state if ΔV>V_{TH}, the traveling vehicle 1 is capable of accurately signaling to the vehicle behind that the traveling vehicle is decelerating.

Conversely, if it is not determined that ΔV>V_{TH} in Step 4 (ST4), the amount of the movement of the slider knob 6, Δp, is obtained in Step 6 (ST6). In this embodiment, the amount of the movement of the slider knob 6 is expressed in a positive value if the knob 6 is operated in the direction of acceleration and in a negative value if the knob 6 is operated in the direction of deceleration. Next, in Step 7 (ST7), the sampling time Δt is obtained.

In the next step, Step 8 (ST8), the position of the slider knob 6 is sampled in the sampling time Δt, and the amount of the movement of the slider knob 6, Δp, during this sampling time Δt is then divided by the sampling time Δt to obtain the moving speed V_{N} of the slider knob 6 (V_{N}=Δp/Δt).

Next, in Step 9 (ST9), it is determined whether the moving speed V_{N} of the slider knob 6 is below a predetermined value V_{NT}. In this embodiment, the predetermined value V_{NT} is a negative value indicating the direction of deceleration.

If the moving speed V_{N} of the slider knob 6 is lower than the predetermined value V_{NT}, that is, if the slider knob 6 has been moved toward the neutral position at a speed faster than the absolute value of the predetermined value V_{NT}, the process goes to Step 10 (ST10), where the brake lights 35 are switched on in a second brake light ON state and then the subroutine illustrated in FIG. 9 is executed.

If the moving speed V_{N} of the slider knob 6 is not less than the predetermined value V_{NT}, in Step 11 (ST11), the data representing the position p of the slider knob 6 is obtained. Next, in Step 12 (ST12), it is determined whether the position p of the slider knob 6 is the neutral position, i.e., whether p=0. If p=0, the process goes to Step 13 (ST13), where the brake lights 35 are switched on in a third brake light ON state and then the subroutine illustrated in FIG. 9 is executed. Conversely, if the position p is not 0, the process goes to Step 14 (ST14), where the brake lights 35 are switched off. Subsequently, this brake light control is to be repeated.

As described above, the execution of the brake light control of this embodiment allows the traveling vehicle to accurately signal the vehicles behind that it is slowing down. The control of the operating conditions of the brake lights according to the embodiment, such as the brightness of the brake lights and the numbers of the brake lights activated, will be described hereafter. In this embodiment, the stop light controller is responsible for controlling the operating conditions of the brake lights 35 according to the difference ΔV between the traveling speed V_{R} and the target speed V_{T} and the moving speed of the slide knob 6.

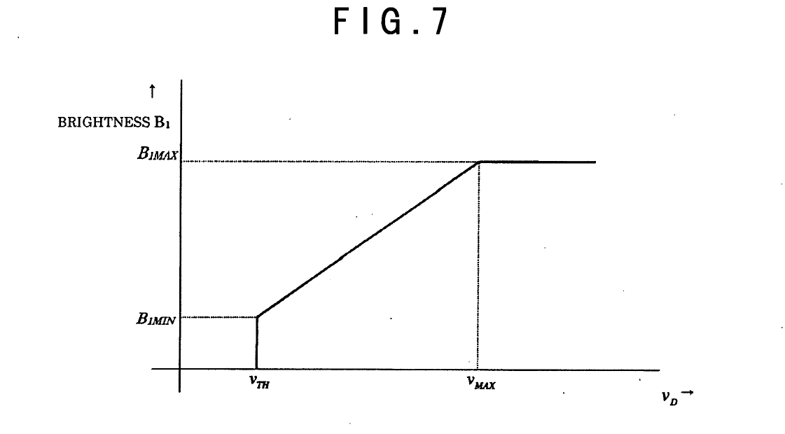

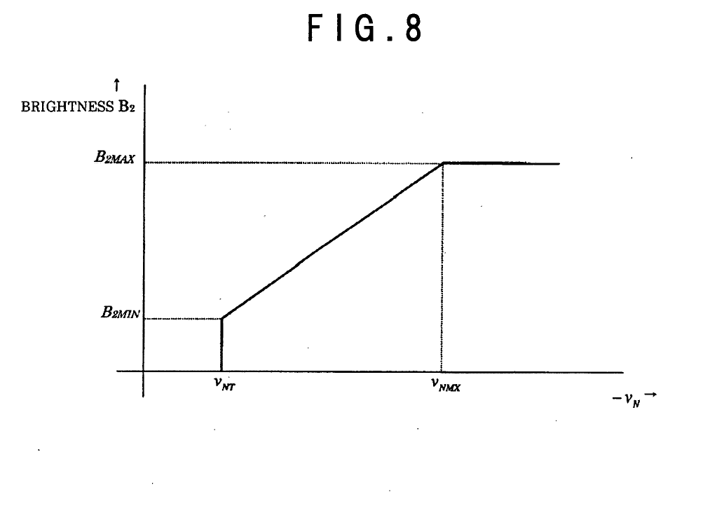

FIG. 7 is a graph showing the correlation between the brightness B1 and the difference ΔV between the traveling speed V_{R} and the target speed V_{T}. FIG. 8 is a graph showing the correlation between the moving speed V_{N} of the slider knob 6 and the brightness B2. FIG. 9 shows a flowchart that describes the manner of controlling the brightness of the brake lights and the number of the brake lights activated.

As shown in FIG. 7, the correlation between the brightness B1 and the difference ΔV between the traveling speed V_{R} and the target speed V_{T} is predefined in this embodiment. The brightness of the brake lights when the difference ΔV between the traveling speed V_{R} and the target speed V_{T} equals the threshold V_{TH} is preset to minimum brightness B1_{MIN}, which may for example be the legally prescribed minimum brightness level for the particular type of vehicle. In addition, the brightness of the brake lights when the difference ΔV between the traveling speed V_{R} and the target speed V_{T} is maximum (i.e., when the traveling speed V_{R} is a maximum speed V_{MAX}, with the target speed V_{T} set to 0) is preset to maximum brightness B1_{MAX}, which is brighter than the minimum brightness B1_{MIN} and may for example be the legally prescribed maximum brightness level for the particular type of vehicle.

This means that the greater the difference ΔV between the traveling speed V_{R} and the target speed V_{T} is, the brighter the brake lights are lit. The graph of FIG. 7 is expressed by the function B1=f(ΔV).

Likewise, the relationship between the moving speed V_{N} of the slider knob 6 and the brightness B2 is also predefined in this embodiment. In the graph of FIG. 8, for ease of understanding, the moving speed V_{N} of the slider knob 6 is reversed in sign, i.e., indicated in negative, showing the correlation between −V_{N} and the brightness B2. In other words, in this graph, the moving speed V_{N} of the slider knob 6 increases in negativity or deceleration toward the right of the figure.

In particular, the brightness of the brake lights when the moving speed V_{N} of the slider knob 6 reversed in sign, i.e., −V_{N}, equals a predetermined value of V_{NT} is set to B2_{MIN}, which may for example be the legally prescribed minimum brightness for the particular type of vehicle. Likewise, the brightness of the brake lights when the moving speed V_{N} of the slider knob 6 reversed in sign, i.e., −V_{N}, equals a maximum value of V_{NMAX} (i.e., when the moving speed V_{N} of the slider knob 6 equals maximum in the direction of deceleration) is set to B2_{MAX}, which is brighter than B2_{MAX} may for example be the legally prescribed maximum brightness for the particular type of vehicle.

This means that the greater the moving speed V_{N} of the slider knob 6 reversed in sign (i.e., −V_{N}) is, in other words, the greater moving speed V_{N} of the slider knob 6 is in the direction of deceleration, the brighter the brake lights are lit. The graph of FIG. 8 is expressed by the function B2=g(V_{N}).

However, measured as an instantaneous value, the brightness B2 decreases quickly, so that occupant M's intention to slow down the traveling vehicle may not be sufficiently communicated to the vehicle behind. To address this problem, this embodiment employs the following function, which allows the brightness B2 to gradually decrease over time:
B3₍ₙ₎=Max(B2,B3₍ₙ₋₁₎)·(Ct_{N}+1), (1)
in which Max (B2, B3₍ₙ₋₁₎) is a function that selects whichever is greater between the calculated B2 and B3, the later of which is the brightness value calculated in the previous cycle. Furthermore, t_{N} is the elapsed time since the first observation of the value set by Max (B2, B3₍ₙ₋₁₎). Designation of a negative value as the constant C, which is an experimentally obtained value, renders the function decremental.

Although the actual brightness B when the brake lights are turned on corresponds to the sum of B1 and B3, in this embodiment, maximum and minimum limits are imposed on this brightness as follows:
B=B1+B3 (where B_{MIN}<B1+B3<B_{MAX})
B=B_{MAX} (where B_{MAX}<B1+B3)
B=0 (where <B1+B3<B_{MIN})

The control of the operating conditions of the brake lights under the foregoing limitations will be described hereafter with reference to the flowchart of FIG. 9.

At the start of the subroutine, it is set that B1=B2=B3=0. First, in Step 101 (ST101), it is determined whether the operating state of the brake lights 35 is the first brake light ON state shown in the flowchart for brake light control of FIG. 6. If the brake lights are in the first brake light ON state, the process proceeds to Step 102 (ST102), in which it is set that B1=f(ΔV).

In Step 103 (ST103), it is determined whether B2≧B3. If it is determined that B2≧B3 in Step 103, the process goes on to Step 104 (ST104), where it is set that t_{N}=0. Subsequently, it is set that B3=B2·(CtN+1) in the Step 105a (ST 105a). If it is not determined that B2≧B3 in Step 103, the process goes on to Step 105b (ST105b), where it is set that B3=B3·(CtN+1). After the brightness B3 is determined in Step 105a or 105b, it is set in Step 106 (ST 106) that tN=tN+Tr, where Tr represents the control cycle time. Next, in Step 107 (ST107), it is set that B=B1+B3.

In Step 108 (ST108), it is determined whether B>B_{MAX}. If B>B_{MAX}, it is then set in Step 109 (ST109) that B=B_{MAX}, and the process proceeds to Step 110. If it is not determined that B>B_{MAX}, the process bypasses Step 109 to proceed to Step 110.

Then, in the next Step 110 (ST110), it is determined whether B<B_{MIN}. If B<B_{MIN}, it is set in Step 111 (ST111) that B=0, and the process proceeds to Step 112. If it is not determined that B>B_{MIN}, the process bypasses Step 111 to proceed to Step 112. In Step 112 (ST112), the brake lights 35 are lit at the calculated brightness B and the control of the brake lights is terminated.

On the other hand, if it is determined in Step 101 that the brake lights are not in the first brake light ON state, it is then set in Step 201 (ST201) that B1=0. Next, in Step 202 (ST202), it is determined whether the brake lights 35 are in the second brake light ON state shown in the flowchart for brake light control of FIG. 6. If the determination in Step 202 indicates that the brake lights are in the second brake light ON state, it is set in Step 203 (ST203) that B2=g(V_{N}) and the process proceeds to Step 103.

If the determination in Step 202 indicates that the brake lights are not in the second brake light ON state, it is then determined in Step 301 (ST301) whether the brake lights 35 are in the third brake light ON state shown in the flowchart for brake light control of FIG. 6. If the determination in Step 301 indicates the brake lights are in the third brake light ON state, it is set in Step 302a (ST302a) that B=B_{MAX} and the process proceeds to Step 303. If it is determined in Step 301 that the brake lights are not in the third brake light ON state, it is then set in Step 302b (ST302b) that B=0 and the process proceeds to Step 303. In Step 303 (ST303), it is set that B1=B2=B3=0 and the process proceeds to Step 112. In Step 112 (ST112), the brake lights 35 are lit at the calculated brightness B and the process returns to and repeats the main control of the brake lights.

As described above, according to the embodiment, the moving speed of the slider knob 6 is calculated, and the brake lights 35 are turned on if it is determined based on the calculated moving speed that the slider knob 6 is moving toward the neutral position at a speed greater than a predetermined value. This enables prompter activation of the brake lights so as to quickly and accurately signal the vehicle behind that this vehicle is in deceleration. Moreover, since this embodiment controls the operating conditions of the brake lights, including the brightness and the frequency of the activation of the brake lights, the occupant M of the traveling vehicle may more accurately warn the vehicle behind of the urgency of the situation regarding that traveling vehicle.

Although the foregoing embodiment employs a slider knob 6 as the input device of a speed-command type, any other suitable device, such as a joystick, pedal, or dial, may also suffice. If a joystick or pedal is employed, its tilt angle may preferably be detected, instead of the distance of its movement as in the foregoing embodiment. Likewise, if a dial is employed, its rotation angle may preferably be detected.

1. A traveling vehicle having an input device of a speed-command type, the traveling vehicle comprising:
a vehicle speed sensor for detecting a traveling speed of the traveling vehicle;
a target speed-setting unit for setting a target speed based on a position of the input device; and
a brake light controller for calculating the difference between the traveling speed and the target speed by subtracting the target speed from the traveling speed and turning on a brake light if the difference is not less than a predetermined value.

2. A traveling vehicle in accordance with claim 1, wherein the input device has a neutral position where the target speed is zero, and the brake light controller calculates a moving speed of the input device and turns on the brake light if the moving speed is greater than a predetermined value with the input device moving toward the neutral position.

3. A traveling vehicle in accordance with claim 1, wherein the brake light controller controls the operating conditions of the brake light according to the size of the difference.

4. A traveling vehicle in accordance with claim 2, wherein the brake light controller controls the operating conditions of the brake light according to the moving speed of the input device.

5. A traveling vehicle in accordance with claim 2, wherein the brake light controller controls the operating conditions of the brake light according to the size of the difference.

6. A traveling vehicle in accordance with claim 5, wherein the brake light controller controls the operating conditions of the brake light according to the moving speed of the input device.

7. A traveling vehicle in accordance with claim 2, wherein the brake light controller controls the operating conditions of the brake light according to the moving speed of the input device.
